(19) United States
(12) Patent Application Publication
(10) Pub. No.: US 2013/0283915 A1
(43) Pub. Date: Oct. 31, 2013

(54) Sonic Exciter

(71) Applicant: Galt B. Booth, Branford, CT (US)

(72) Inventor: Galt B. Booth, Branford, CT (US)

(21) Appl. No.: 13/865,573

(22) Filed: Apr. 18, 2013

Related U.S. Application Data
(60) Provisional application No. 61/639,761, filed on Apr. 27, 2012.
(60) Provisional application No. 61/785,634, filed on Mar. 14, 2013.

(51) Int. Cl. G01N 29/22; G01N 29/04

(52) U.S. Cl. CPC G01N 29/22; G01N 29/04
USPC 73/584; 73/662

(57) ABSTRACT

An apparatus for sonic excitation of a surface has a housing defining an open cavity facing the surface. At least one speaker is positioned to introduce sound to the cavity. The housing comprises a gasket for sealing with the surface. A valve is coupled to the cavity to allow the cavity to be maintained at a pressure below an external pressure.

### CROSS-REFERENCE TO RELATED APPLICATIONS

Benefit is claimed of U.S. Patent Application Ser. Nos. 61/639,761 and 61/785,634, filed Apr. 27, 2012 and Mar. 14, 2013 and both entitled “Sonic Exciter”, the disclosures of which are incorporated by reference in their entireties herein as if set forth at length.

### BACKGROUND OF THE INVENTION

The invention relates to art conservation. More particularly, the invention relates to sonic systems for determining the condition of frescos and similar murals.

A fresco mural (e.g., painting or mosaic) is a painting made on a masonry wall by brushing pigment-water mixtures into a fresh plaster layer, or by inlaying small pieces of colored glass, stones, or other materials into a fresh plaster layer. Fresco murals have endured thousands of years.

An exploratory technique has been used to evaluate fresco substrates by using a loudspeaker system to direct sound waves toward the fresco mural and a laser interferometer vibration sensor to measure the resulting motion of many locations of the mural. A sound pressure level of 90 to 100 dB is needed to obtain enough motion to measure, but makes the location near the painting too noisy for normal use. See, J. Vignola, J. Bucaro, J. Tressler, D. Ellingston, A. Kurdila, G. Adams, B. Marchetti, A. Agnani, E. Esposito, E. P. Thomasini, “Proper Orthogonal Decomposition Analysis of Scanning Laser Doppler Vibrometer Measurements of Plaster Status at the US Capitol”, 6th Int. Conf. on Vibration Measurements by Laser Techniques, Proc. SPIE Vol 5503. See, also, U.S. Pat. No. 6,728,661 of Cannelli et al., identifying use of a wideband acoustic detector.

U.S. Pat. No. 7,502,694 (the '694 patent, the disclosure of which is incorporated by reference herein in its entirety as if set forth at length) discloses a sonic exciter having a frame-like housing surrounding a cavity and covered by a transparent pane. The open end of the cavity is held in close proximity to the wall via a scaffold or similar structure. The transparent pane permits optical vibration sensing techniques to be used to measure the response of the surface being examined.

### SUMMARY OF THE INVENTION

One aspect of the disclosure involves an apparatus for sonic excitation of a surface comprising a housing defining an open cavity facing the surface and at least one speaker positioned to introduce sound to the cavity. The housing comprises a gasket for sealing with the surface. A valve or vacuum source is coupled to the cavity to allow the cavity to be maintained at a pressure below an external pressure.

In additional or alternative embodiments of any of the foregoing embodiments, the housing comprises an inner member and an outer member. The at least one speaker is mounted to the inner member and the valve or vacuum source is mounted to the outer member.

In additional or alternative embodiments of any of the foregoing embodiments, a bundle of 6-30 tubes connects the housing to the vacuum source.

In additional or alternative embodiments of any of the foregoing embodiments, the housing has an essentially rectangular planform.

In additional or alternative embodiments of any of the foregoing embodiments, the apparatus has a plurality of removable adapter elements for accommodating the sidewall to different possible curvatures of the surface.

In additional or alternative embodiments of any of the foregoing embodiments, there are two said speakers electrically coupled to be driven in phase with each other.

In additional or alternative embodiments of any of the foregoing embodiments, there are two said speakers facing each other.

In additional or alternative embodiments of any of the foregoing embodiments, the housing comprises a laminate of corrugated plastic layers.

In additional or alternative embodiments of any of the foregoing embodiments, a central said layer is oriented 90° to inner and outer said layers.

Another aspect of the disclosure involves a system for determining a condition of a mural and substrate combination comprising: the apparatus; and one or more vibration detectors.

Another aspect of the disclosure involves an apparatus for examination of a fresco mural comprising a housing defining an open cavity facing the mural, a sound source positioned to introduce sound to the cavity, a vacuum source, and a vibration detector positioned to detect vibrations of the mural induced by the sound.

In additional or alternative embodiments of any of the foregoing embodiments, the vibration detector comprises a contact vibration sensor.

In additional or alternative embodiments of any of the foregoing embodiments, the system comprises a processor coupled to the detector and programmed by at least one of hardware and software to analyze the return.

In additional or alternative embodiments of any of the foregoing embodiments, a controller is coupled to the speaker and the vibration detector.

Another aspect of the disclosure involves a method for inspecting a mural and substrate combination. A sound generating apparatus comprising a housing defining an open cavity is provided having a sound source is positioned to introduce sound to the cavity. An open end of the cavity is positioned in contact with the mural. A pressure in the housing is reduced to retain the housing against the mural. Sound is generated from the sound source so as to excite the mural. Vibration induced by the sound is detected. The detected vibration is evaluated so as to determine a condition of the combination.

In additional or alternative embodiments of any of the foregoing embodiments, the sound is sequentially or progressively generated at a plurality of different frequencies.

In additional or alternative embodiments of any of the foregoing embodiments, the positioning is repeated for a plurality of positions. For each of the positions, the directing and detecting are repeated for a plurality of locations in a field of around the housing. The evaluating comprises determining at least one of: a transverse dimensional parameter of a void or adhesion failure; a depth of a void or adhesion failure; and a looseness of a piece of mural over a void or adhesion failure.

In additional or alternative embodiments of any of the foregoing embodiments, the method further comprises selecting and installing one or more adapters for matching curvature of the substrate to a cavity perimeter.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a partially exploded view of a first sonic exciter main unit.

FIG. 2 is a rear view of an inner member of the unit of FIG. 1.

FIG. 3 is a partially exploded view of a second sonic exciter main unit.

FIG. 4 is a side view of the second sonic exciter.

FIG. 5 is a rear view of the second sonic exciter main unit with back panel removed.

FIG. 6 is a front view of the second sonic exciter main unit.

Like reference numbers and designations in the various drawings indicate like elements.

### DETAILED DESCRIPTION

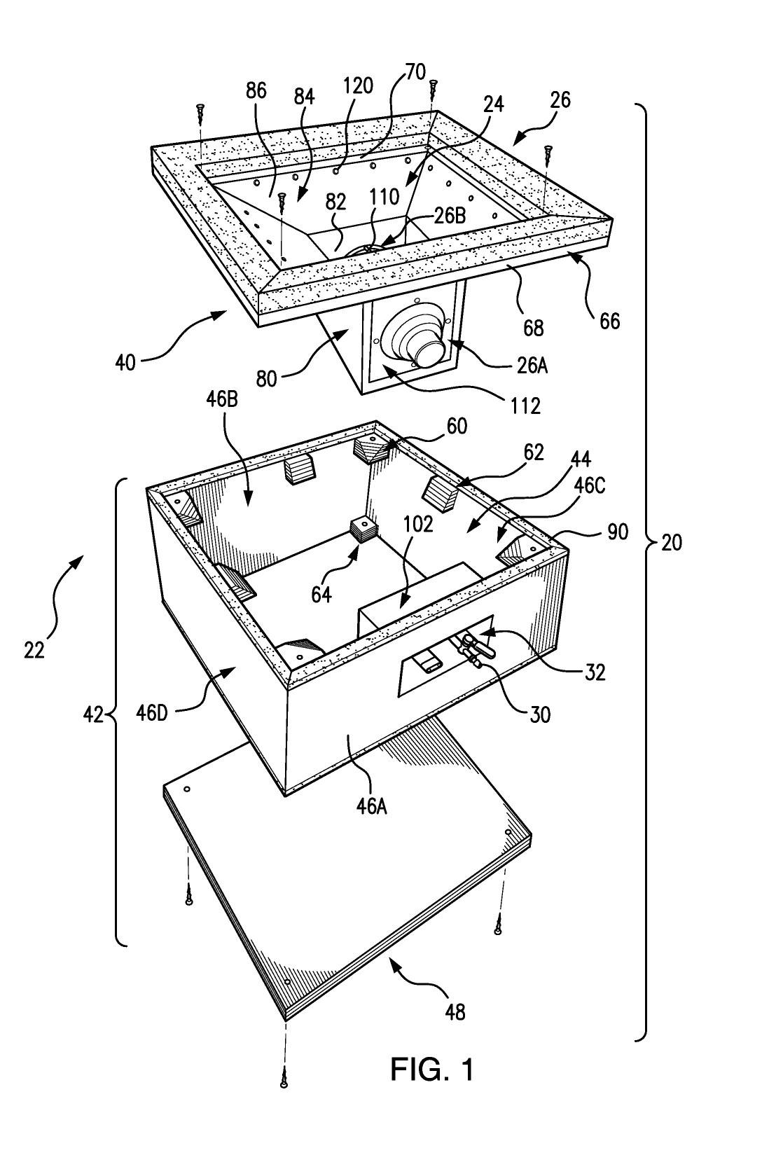

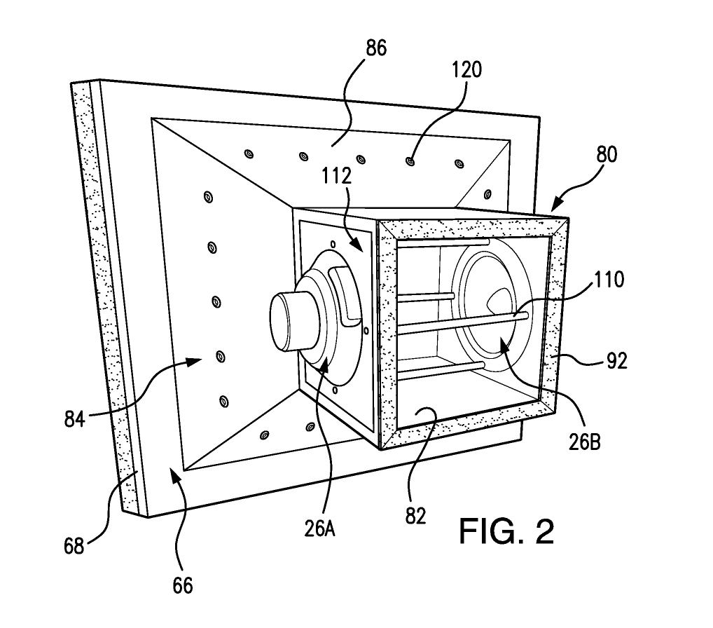

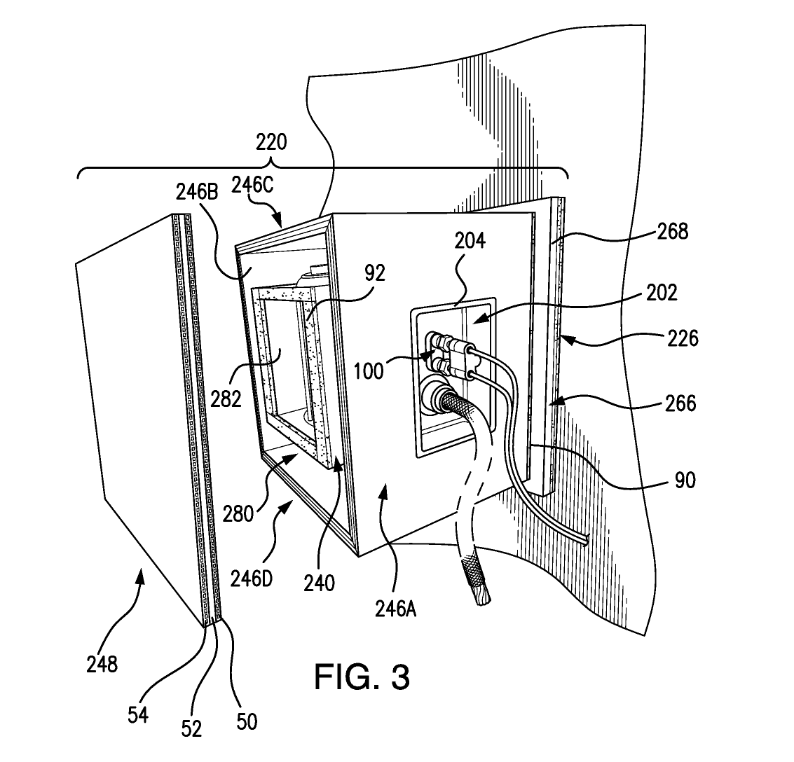

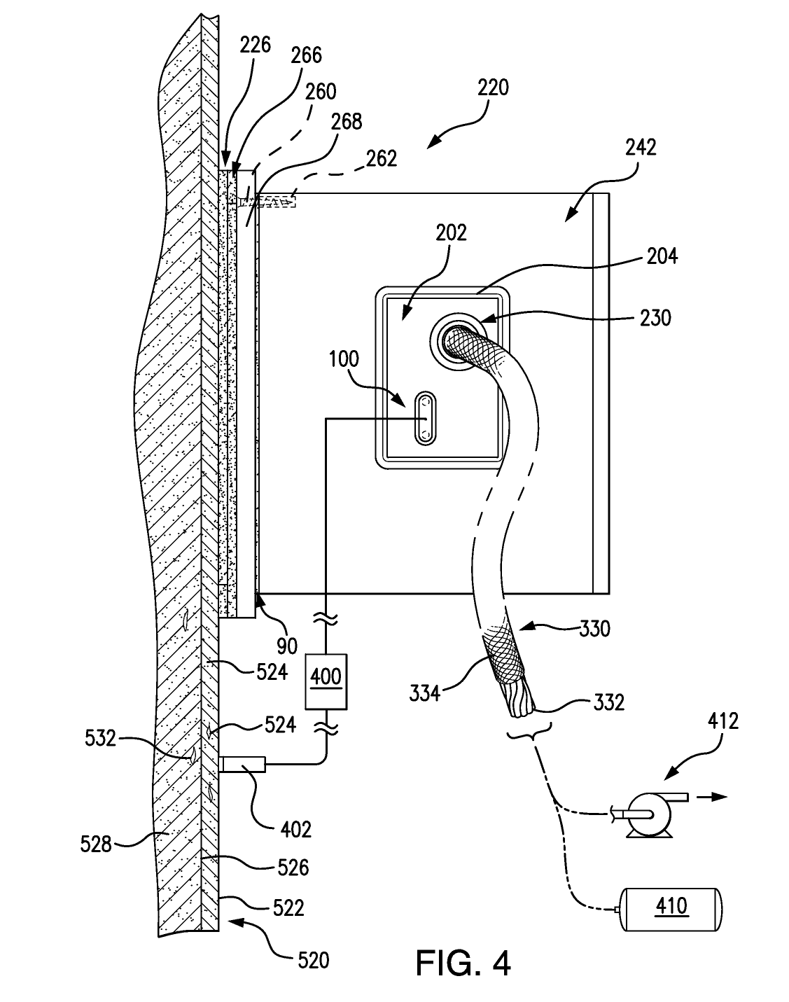

Two main embodiments of a sonic exciter main unit are illustrated in the drawings. A first unit 20 is shown in FIGS. 1 and 2. A second unit 220 is shown in FIGS. 3-6. FIGS. 3-6 further show associated equipment which may be used with either main unit. The exemplary second unit is slightly smaller than the exemplary first unit. However, size of either configuration may vary and features shown in one configuration may be transferred to the other. For convenience, some features of the two main units are referenced with different reference numerals. Others may be referenced with the same numerals. In general, the sonic exciter comprises a main exciter unit (main unit 20, 220) having a housing 22, 222 defining an open cavity 24 for facing a surface 522 (FIG. 4, e.g., of a wall, ceiling, or the like 520) to be excited and a speaker 26A and 26B for delivering sound to that cavity. A gasket 26, 226 seals the cavity 24 to the wall.

Means may be provided for drawing and maintaining a light vacuum in the cavity 24 to retain the unit to the surface 522 by differential pressure. Exemplary means comprises a fitting 30 and manually actuatable valve 32 on the main unit 20 which may be coupled to a vacuum source (FIG. 4, e.g., a vacuum bottle 410 or a vacuum pump 412). Upon connection and full or partial opening of the valve (if not already opened) air is withdrawn from the body and the difference in external pressure above internal pressure secures the body to the surface. Thereafter, the valve may be closed and a vacuum source disengaged. Alternative implementations may involve a sustained maintenance of the vacuum by the source in which case, a fitting 230 (FIG. 4, e.g., threaded male hose fitting) may lack a valve.

Each of the two exemplary housings 22, 222 comprises an inner member 40, 240 and an outer member 42, 242. The exemplary inner members carry the speakers and define/bound the open cavity 24. The exemplary inner members are mounted within the outer members to define an interior space 44 therebetween.

The exemplary outer members are each formed as a box-like structure having a sidewall assembly of four individual walls 46A, 246A, 46B, 246B, 46C, 246C, and 46D, 246D. The exemplary outer member further comprises a rear wall or panel 48, 248.

Rigid structural portions of the housing inner and outer members may be formed of a lightweight material. An exemplary material is a lamination of multiple layers 50, 52, 54 (FIGS. 3&5) of extruded twin wall corrugated plastic sheet material. An exemplary material is a polypropylene or polyethylene material such as sold under the trademark HI-CORE by Metraplast Industries, Inc. of Berthiervile, Quebec, Canada. In an exemplary implementation using such material, main panels are provided by a three-layer lamination of 4 mm sheets with the corrugations of the center layer 90° out of phase with those of the other layers (see rear panel of FIG. 3). The lamination may be performed via adhesive or solvent cementing. Large panels of the laminate may be pre-made and then cut to make individual pieces (e.g., via conventional woodworking-type techniques). In an exemplary technique, three foot by three foot (91 cm by 91 cm) square plies are cut from as-delivered sheets. These are washed with benzene or other solvent to remove finger oils, etc. The plies are then optionally sanded and the debris removed (e.g., via air blowing, wiping, etc., optionally using such solvent). They are then assembled with the center ply out of phase with the other plies and bonded together (e.g., via pre-spraying both sides with spray adhesive such as 3M SUPER 77 multipurpose adhesive). The individual pieces for forming the inner and outer members may then be cut from the laminates using a table saw.

After manufacturing the individual pieces or after their subsequent assembly, some or all of the ends of the corrugations may be closed/sealed. This may be done via locally filling and/or covering the exposed ends of the corrugations. For example, a two-part epoxy may be used to locally fill and secure a cover. The cover may be formed from strips of the facesheets of the corrugated material (e.g., after the webs are cut to separate the two facesheets and then the web remnants are sanded off). Alternatively, sheet material may be purchased for this purpose.

The laminated pieces may be assembled to each other via some combination of adhesives and fasteners. For example, edges of box structures may be sawn at a forty-five degree angle and secured to each other via cementing. Exemplary cementing involves a 10:1 ratio of structural adhesive (e.g., 3M SCOTCH WELD structural plastic adhesive DP8005). For forming the inner member, a wax paper may be applied to a buck so that the laminate pieces do not bond to the buck.

The exemplary first unit 20 (FIG. 1) shows mounting blocks 60, 62, 64 along the sidewall of the housing outer member for assisting in the mounting of the inner member to the outer member and of the outer member rear wall to the sidewall. These blocks may be formed by stacking the corrugated plastic sheet material and may be formed either by cutting individual plies to specific shapes prior to assembly or by cutting assembled laminate. The blocks may be screwed and cemented to the sides of the housing outer member. Optionally, the blocks may have threaded inserts for screwing to the inner member (or back wall). Removal of the outer member from the inner member, once assembled, allows servicing of the speakers.

In the second unit 220, the front frame is not secured to blocks but is, instead, secured (e.g., screwed 260 (FIG. 4)) to threaded inserts 262 inserted into the forward edges of the side walls. Exemplary adhesive between panels is a structural acrylic adhesive such as 3M Scotch-Weld DP8005; whereas, the threaded inserts are secured with epoxy which provides more working time than the acrylic.

The exemplary inner members each comprise a face frame 66, 266 of the laminate. An exemplary face frame is rectangular in planform, more particularly, square having a corresponding outer perimeter 68, 268 and inner aperture 70, 270. The exemplary face frame 66 is 16 inch by 16 inch by 0.5 inch thick (41 cm by 41 cm by 1.3 cm) with a 13 inch by 13 inch aperture (33 cm by 33 cm). The forward (wall-facing) face of the face frame may bear the gasket (e.g., formed of a closed cell foam (e.g., one inch rubber for 26) which may be preformed in a strip/tape with an adhesive backing on one side for securing to the faceplate). The gasket may have sufficient thickness and compliance to conform not merely to surface irregularities in a nominally flat surface, but also to singly or doubly curved surfaces (e.g. of an arched or domed ceiling having radii of curvature typical for such surfaces). The gasket 226 has two layers (each thinner than 26) of four legs each. Joints between adjacent legs at the corners are sealed with silicone sealant. The two layers locally overlap at the corners (so that their joints are not coplanar) for strength.

The exemplary first unit housing outer member 42 is a rectangular (more particularly, square) planform box structure whose planform corresponds to that of the inner member and has four sidewalls and a rear wall spanning them. In an exemplary 16 inch by 16 inch (41 cm by 41 cm) face frame unit, the exemplary planform is thus 16 inch by 16 inch and an exemplary height is 11 inch 28(m) without the rear wall.

In the exemplary square planform exciter, exemplary width and length of the face frame aperture are in the vicinity of 8-20 inches, more narrowly, 11-15 inches (28-38 cm) (or 7-10 inches (18-25 cm) for the smaller unit 220 with a 9-12 inch (23-30 cm) range of outside dimension, but not a lesser reduction in depth relative to the larger unit 20). For hypothetical non-square rectangular planforms, the respective length and width may also be within such ranges.

Alternatively, adaptor elements may be provided to match surface curvature along two or four legs of the frame. Exemplary adaptor elements for a singly-curved surface include a pair 380 (FIG. 6) of curved elements and may also include a pair 382 of angled end elements. For doubly curved surfaces two pair of curved elements 380 may be provided. These may be formed of material similar to the gasket.

An opposite end section of the inner member is a sound generator section 80, 280 to which the speaker(s) are mounted. The exemplary implementation involves a pair of speakers coaxially spaced apart and opposing each other face-to-face across the sound generator section. The exemplary sound generator section is formed as a rectangular-section (more particularly, square) tube formed by four walls of the laminate.

The inner surface 82, 282 of the sound generator section is smaller in planform than the faceplate aperture. For example, it may be an exemplary 20-70% of the corresponding aperture transverse linear dimension. To join these, an expander/diffuser/divergent section 84, 284 is provided. The exemplary expander/diffuser/divergent section is of frusto-pyramidical form, again with four associated walls 86, 286 of the laminate extending to the face frame central aperture so that the face frame protrudes laterally outward from the outboard surface of the diffuser section to form a lip/flange/ledge. The back side of the faceplate along the ledge mates and seals with a forward rim of the housing outer member.

The exemplary rear wall 48 may be removably mounted to the sidewall assembly. A gasket 90 (FIG. 1) may be provided on one or both of the flange and outer housing member forward rim to seal the two. In the second unit 220, the exemplary rear wall perimeter may be adhered rather than screwed in place (e.g., directly to the edges of the four adjacent walls).

An additional gasket 92 (FIG. 2) may be provided along the aft rim of the sound generator section sidewall structure to contact and cushion engagement with the underside (inside face) of the rear wall of the outer housing when vacuum is drawn.

The outer housing may bear vacuum 30, 230 and electrical 100 connections. In the exemplary unit 20, one of the side panels is provided with a mounting plate 102 to which the vacuum valve/fitting (e.g., ball valve 32 and male hose fitting 30) and electrical connectors (e.g., banana connectors such as a dual connector 100) are mounted.

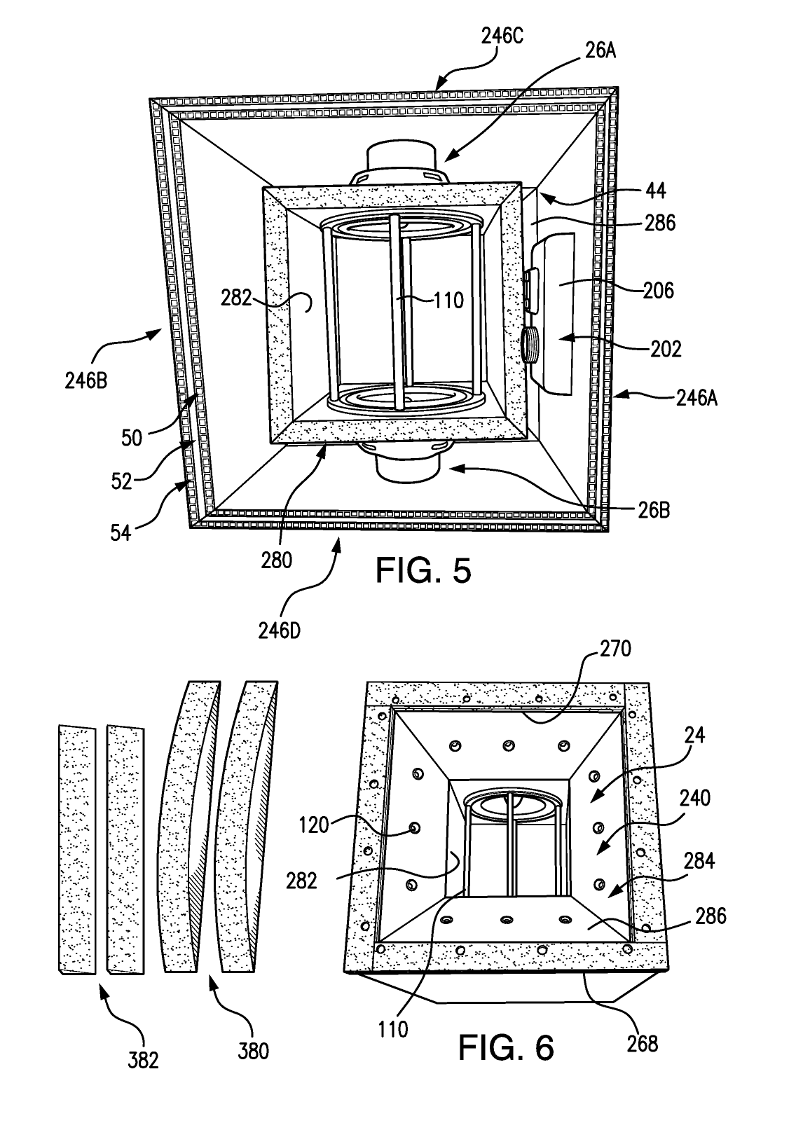

In the unit 220, the electrical and vacuum connectors are mounted in a pre-molded (e.g., of polyethylene, polypropylene, polystyrene, or the like) pocket (cup) 202 inserted into an aperture in a wall and having a flange 204 holding it to the outer surface of the adjacent side. The flange of the connector cup is sealed (e.g., with a silicone adhesive) whereas the perimeter/side 206 (FIG. 5) of the body of the cup is secured within the aperture in the sidewall via the acrylic adhesive.

In both units, internally, the electrical connectors are connected by wiring (not shown) to the speakers. The exemplary speakers are hardwired to operate in phase with each other. Alternative implementations may involve independent control which may then be tuned for in-phase operation.

The exemplary speakers are held precisely spaced-apart from each other via a plurality of spacers 110 (FIG. 2) (e.g., aluminum rods). The drawings additionally show metal plates 112 (e.g., aluminum) around the speakers along the sides of the sound generator section. The plates connect to the outer edge of the speaker cone and, not shown, support the connections to the speaker coil.

The cavity 24 within the inner housing is vented to the space between the inner and outer housings. An exemplary venting is provided by hollow brass rivets 120 (FIGS. 2 and 6) penetrating sides of the frusto-pyramidical diffuser (e.g., five on each side shown for the unit 20 and three for the unit 220). These may be placed into holes drilled in the diffuser. They also may be sealed relative to the holes so that the interior corrugations are not exposed to vacuum.

In the unit 220 (FIG. 4) to draw vacuum, instead of a single hose (e.g., vinyl), a bundle 330 of smaller vinyl tubes 332 (e.g., 6-30 or 10-25 with inner diameter less than 0.25 inch 6.4 mm (e.g., about 18 tubes at ⅛ inch ID and 3/16 OD (3.2 mm ID and 4.8 mm OD)) is used attached to a manifold fitting (e.g., female threaded) to engage the single fitting (e.g., threaded male) on the unit. The presents higher impedance for sounds from the vacuum pump coming into the unit than a single layer tube/hose would (if the pump is run during testing). The tube bundle may be held in a nylon mesh sheath 334.

The sonic exciter may be part of a system further including a driver and/or control unit 400 (FIG. 5) (e.g., including a processor programmed to operate the unit and vibration detector) coupled to the speakers to drive the speakers. Additionally, a vibration detector 402 may be provided (e.g., operating independently or coupled to the driver and control unit to be commonly controlled/used).

In operation, the user may connect the vacuum source 410 or 412 to the connector. An exemplary vacuum source is a vacuum bottle 410 previously pumped-down and having a vacuum hose with a complementary fitting and its own valve. An alternative is a pump 412. The user may wear the vacuum bottle on a shoulder strap, neck strap, backpack, or the like. The user may connect the hose fitting to the main unit fitting and open the main unit valve (if not already opened). The user may then place the main unit against the surface to be examined with its gasket in contact with the surface. The user may then open the vacuum source valve exposing the main unit interior to vacuum and reducing the pressure below pressure surrounding the main unit. This pressure differential will be sufficient to maintain the main unit in place frictionally via the gasket. Exemplary such surfaces may be of any orientation. The user may determine sufficiency of the vacuum via observing the degree of compression of the gasket. Thus, an exemplary may be relatively thick (e.g., in excess of 1 centimeter, more particularly, in excess of 1.5 or 2.0 centimeter). The user then closes both valves and disengages the vacuum source. If not already connected, the user may then connect the driver wiring from the driver and control unit to the electrical connectors. The user may then commence driving of the speakers.

Exemplary driving is via an alternating current (AC) signal (discussed further below). The pressure pulses generated by the speakers pass down the cavity to the surface 522 and excite the surface and underlying structure. This vibration is transmitted laterally beyond the main unit. One or more vibration detectors may then be used in a region surrounding the main unit. Exemplary vibration detectors 402 include contact accelerometers or velocity sensors. A relative absence of motion indicates firm local attachment of the fresco to the wall. The detectors may be sequentially repositioned to cover a field surrounding the sonic exciter. The extent of this region may vary based upon a number of factors including the type of surface being examined, the type of vibration detection system being used, the desired inspection resolution, and the sound intensity being used. After placing the accelerometer at a given location in the field, the user may sequentially scan through a plurality of pre-determined test frequencies within the range. At each of the frequencies, the user may observe a numerical or other visual indication of detected motion (e.g., on a display coupled to the sensor) so as to determine the presence of a defect. After the appropriate field surrounding the main unit has been examined, the main unit may be repositioned to a further location and the process repeated until a desired overall portion of the surface has been appropriately surveyed.

An exemplary target retention (for embodiments lacking a pump or where the pump is disengaged and the valve 32 closed) duration is twenty-four hours on a vertical wall. However, shorter durations may be necessitated by surface irregularities and porosities.

In manufacturing, a test fixture may be provided with a flat vertical surface (e.g., clean sheetrock) and the unit subject to vacuum as discussed above. If the unit is not retained against the test surface for a desired threshold (e.g., twenty-four hours) leaks may be assumed. If leaks are assumed, then a pressure test may be performed by clamping the unit down against a surface and pressurizing the interior. Leaks may be detected via application of a soapy water mixture and observing bubbles. If any such bubbles are observed, the local area may be repaired via a sealant, adhesive, or the like.

The loudspeakers of the exemplary sonic exciter are driven by the sonic exciter driver, typically in the 50 to 1000 Hz frequency range, more narrowly 150-400 Hz. An exemplary driver may be a downsized version of that of the '694 patent (reduced size of the exciter unit meaning power may be reduced by a factor in the vicinity of ten). However, this lower power requirement also suggests use of commercially available power amplifiers.

Further modifications may be made. One area for modifications involves lightening the unit and/or shifting the center of mass toward the wall. This can reduce the amount of vacuum needed to retain the unit under given conditions. A particular aspect of this involves shifting the speakers toward the wall. For example, if the array of rods is rotated 45° about the speaker axis from that shown, the speakers may be shifted slightly toward the diffuser and unit depth correspondingly reduced.

One or more embodiments of the present invention have been described. Nevertheless, it will be understood that various modifications may be made without departing from the spirit and scope of the invention. Accordingly, other embodiments are within the scope of the following claims.

What is claimed is:

1. An apparatus for sonic excitation of a surface comprising:
a housing defining an open cavity facing the surface; and
at least one speaker positioned to introduce sound to the cavity, wherein:
the housing comprises a gasket for sealing with the surface; and
a valve or vacuum source is coupled to the cavity to allow the cavity to be maintained at a pressure below an external pressure.

2. The apparatus of claim 1 wherein:
the housing comprises an inner member and an outer member;
the at least one speaker is mounted to the inner member; and
the valve or vacuum source is mounted to the outer member.

3. The apparatus of claim 2 wherein:
a bundle of 6-30 tubes connects the housing to the vacuum source.

4. The apparatus of claim 1 wherein:
the housing has an essentially rectangular planform.

5. The apparatus of claim 1 further comprising:
a plurality of removable adapter elements for accommodating the sidewall to different possible curvatures of the surface.

6. The apparatus of claim 1 wherein:
there are two said speakers electrically coupled to be driven in phase with each other.

7. The apparatus of claim 1 wherein:
there are two said speakers facing each other.

8. The apparatus of claim 1 wherein:
the housing comprises a laminate of corrugated plastic layers.

9. The apparatus of claim 8 wherein:
a central said layer is oriented 90° to inner and outer said layers.

10. A system for determining a condition of a mural and substrate combination comprising:
the apparatus of claim 1; and
one or more vibration detectors.

11. An apparatus for examination of a fresco mural comprising:
a housing defining an open cavity facing the mural;
a sound source positioned to introduce sound to the cavity;
a vacuum source; and
a vibration detector positioned to detect vibrations of the mural induced by the sound.

12. The apparatus of claim 11 wherein:
the vibration detector comprises a contact vibration sensor.

13. The system of claim 11 further comprising:
a processor coupled to the detector and programmed by at least one of hardware and software to analyze the return.

14. The apparatus of claim 11 wherein a controller is coupled to the speaker and the vibration detector.

15. A method for inspecting a mural and substrate combination comprising:
providing a sound generating apparatus comprising:
a housing defining an open cavity; and
a sound source positioned to introduce sound to the cavity;
positioning an open end of the cavity in contact with the mural;
reducing a pressure in the housing to retain the housing against the mural;
generating sound from the sound source so as to excite the mural;
detecting vibration induced by the sound; and
evaluating the detected vibration so as to determine a condition of the combination.

16. The method of claim 15 wherein:
the sound is sequentially or progressively generated at a plurality of different frequencies.

17. The method of claim 15 wherein:
the positioning is repeated for a plurality of positions;
for each of the positions, the directing and detecting are repeated for a plurality of locations in a field of around the housing; and
the evaluating comprises determining at least one of:
a transverse dimensional parameter of a void or adhesion failure;
a depth of a void or adhesion failure; and
a looseness of a piece of mural over a void or adhesion failure.

18. The method of claim 15 further comprising:
selecting and installing one or more adapters for matching curvature of the substrate to a cavity perimeter.
